(19) United States
(12) Patent Application Publication
(10) Pub. No.: US 2011/0267314 A1
(43) Pub. Date: Nov. 3, 2011

(54) OPTICAL TOUCH-SENSING DISPLAY MODULE

(75) Inventor: Yen-Lang Huang, Hsinchu County (TW)

(73) Assignee: SONIX TECHNOLOGY CO., LTD., Hsinchu (TW)

(21) Appl. No.: 12/973,931

(22) Filed: Dec. 21, 2010

(30) Foreign Application Priority Data
May 3, 2010 (TW) 99114078

(51) Int. Cl. G06F 3/042

(52) U.S. Cl. 345/175

(57) ABSTRACT

An optical touch-sensing display module including a liquid crystal display (LCD) module and at least two optical touch-sensing units is disclosed. The LCD module has a display surface and a side surface at periphery of the display surface. The LCD module includes a frame disposed at periphery of the display surface and the side surface. The frame has an opening for exposing the display surface. The optical touch-sensing units are disposed between the frame, the display surface and the side surface and define a sensing space upon the display surface. Each of the optical touch-sensing units has a sensing window facing to the sensing space, and senses an object in the sensing space through the sensing window.

### CROSS-REFERENCE TO RELATED APPLICATION

This application claims the priority benefit of Taiwan application serial no. 99114078, filed on May 3, 2010. The entirety of the above-mentioned patent application is hereby incorporated by reference herein and made a part of this specification.

### BACKGROUND

1. Field of the Invention

The invention relates to a liquid crystal display module. Particularly, the invention relates to an optical touch-sensing display module.

2. Description of Related Art

In recent years, with continuous progress of image display technology, since a touch screen has an advantage of performing input directly through a touch operation, it become a commonly used display device in the market, and is widely used in various electronic products such as automatic teller machines, terminals of sale points, tourist guide systems and industrial control systems, etc.

General designs of touch panels include resistive, capacitive, optical, acoustic wave and electromagnetic touch panels, etc. Taking an optical touch liquid crystal display (LCD) as an example, generally, after assembling of a LCD module is completed, touch control units including a light source, a signal processor and a sensor, etc. are assembled next to a display surface of the LCD module. However, such method may cause a problem that when a casing of the LCD is assembled, a space has to be remained for containing these touch control units, which may cause a burden for designing and assembling the casing.

### SUMMARY OF THE INVENTION

The invention is directed to an optical touch-sensing display module, which has an integral design structure.

An embodiment of the invention provides an optical touch-sensing display module including a liquid crystal display (LCD) module and at least two optical touch-sensing units. The LCD module has a display surface and a side surface located at periphery of the display surface. The LCD module includes a frame located at periphery of the display surface and the side surface. The frame has an opening for exposing the display surface. The optical touch-sensing units are disposed between the frame and the LCD module, where each of the optical touch-sensing units has a sensing window facing to a sensing space. Each of the optical touch-sensing units senses an object in the sensing space through the sensing window.

An embodiment of the invention provides an optical touch-sensing display module including a LCD device, a frame and a plurality of optical touch-sensing units. The LCD device has a display surface and four side surfaces. The frame is disposed at periphery of the LCD device, and a containing space is formed between the frame and the LCD device. The frame has an opening for exposing the display surface, and defines a sensing space upon the display surface. The optical touch-sensing units are disposed in the containing space, where each of the optical touch-sensing units has a sensing window facing to the sensing space. Each of the optical touch-sensing units senses an object in the sensing space through the sensing window.

An embodiment of the invention provides an optical touch-sensing display module including a LCD module, at least two optical touch-sensing units and a plurality of light guides. The LCD module has a display surface and a side surface at periphery of the display surface. The LCD module includes a frame located at periphery of the display surface and the side surface. The frame has an opening for exposing the display surface, and a containing space is formed between the frame and the display surface and the side surface of the LCD module. The optical touch-sensing units are disposed in the containing space, and define a sensing space upon the display surface. Each of the optical touch-sensing units has a sensing window, and the sensing window is located above the display surface and faces to the sensing space. Each of the optical touch-sensing units includes a light source, a system chipset and at least one optical element. The system chipset includes a signal processor and a sensor, and the sensor directly faces to the sensing window. The optical element is disposed between the sensor and the sensing window. The light guides are disposed in the containing space, and each of the light guides has two light-incident surfaces on side surfaces and a light-emitting surface between the light incident surfaces. The light-emitting surface faces to the sensing space, and the light sources are adjacent to at least one of the light-incident surfaces, so that light emitted from the light sources is transmitted to the sensing space through the light incident surfaces and the light-emitting surfaces. The sensor of each of the optical touch-sensing units senses the light variation in the sensing space through the sensing window when at least one object enters the sensing space.

An embodiment of the invention provides an optical touch-sensing display module including a LCD device, a frame, a plurality of optical touch-sensing units and a plurality of light guides. The LCD module has a display surface and four side surfaces. The frame is disposed at periphery of the LCD device, and a containing space is formed between the frame and the LCD device. The frame has an opening for exposing the display surface, and defines a sensing space upon the display surface. The optical touch-sensing units are disposed in the containing space, where each of the optical touch unit has a sensing window facing to the sensing space. Each of the optical touch-sensing units includes a light source, a system chipset, a circuit board and at least one optical element. The system chipset includes a signal processor and a sensor, and the sensor directly faces to the sensing window. The circuit board is disposed on at least one of the side surfaces of the LCD device, the system chipset is mounted on the circuit board, and the light source is electrically connected to the circuit board. The optical element is disposed between the sensor and the sensing window. The light guides are disposed in the containing space at periphery of the display surface and are located next to the optical touch-sensing units. Each of the light guides has two light-incident surfaces on side surfaces and a light-emitting surface between the light-incident surfaces. The light-emitting surface faces to the sensing space. The light sources of the optical touch-sensing units are adjacent to the light-incident surfaces, so that light emitted from the light sources is transmitted to the sensing space through the light guides. The sensor of each of the optical touch-sensing units senses a light variation in the sensing space through the sensing window when at least one object enters the sensing space.

According to the above descriptions, in the optical touch-sensing display module of the invention, the optical touch-sensing units are assembled on the LCD module, and according to such integral design, when the LCD module and the frame are assembled, the optical touch-sensing units can be simultaneously assembled, so as to save follow-up assembly processes. Moreover, the assembled optical touch-sensing display module has a high application range, and when a casing of the LCD is assembled, the problem of remaining a containing space for the optical touch-sensing units is avoided, so as to save the assembly processes and cost.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of an optical touch-sensing display module according to an embodiment of the invention.

FIG. 2 is a partial cross-sectional view of the optical touch-sensing display module of FIG. 1.

FIG. 3 is a partial cross-sectional view of an optical touch-sensing display module according to another embodiment of the invention.

FIG. 4 is a component block diagram of an optical touch-sensing unit of FIG. 2.

FIG. 5 is a top view of an optical touch-sensing display module according to another embodiment of the invention.

FIG. 6 is a partial cross-sectional view of an optical touch-sensing display module according to another embodiment of the invention.

FIG. 7 is a partial cross-sectional view of an optical touch-sensing display module according to another embodiment of the invention.

FIG. 8 is a partial cross-sectional view of an optical touch-sensing display module according to another embodiment of the invention.

FIG. 9 is a partial cross-sectional view of an optical touch-sensing display module according to another embodiment of the invention.

### DETAILED DESCRIPTION OF DISCLOSED EMBODIMENTS

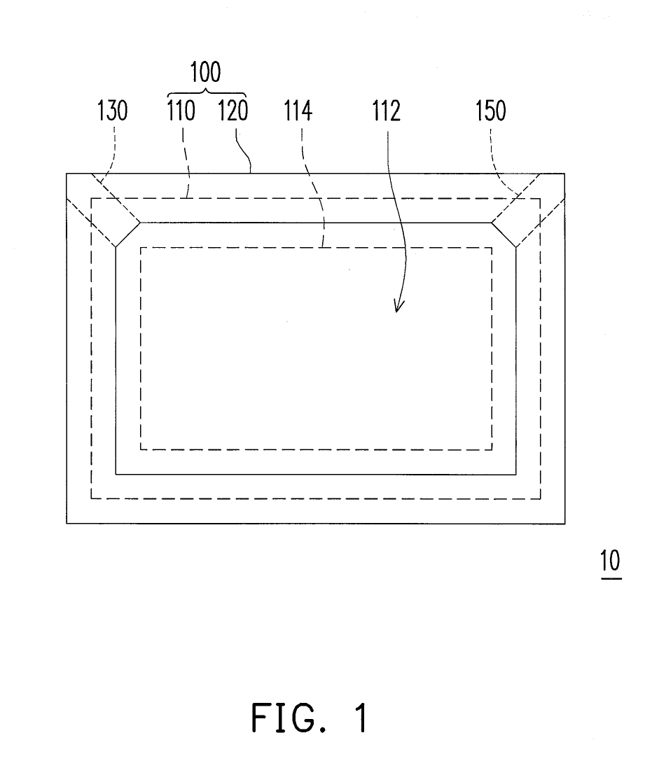

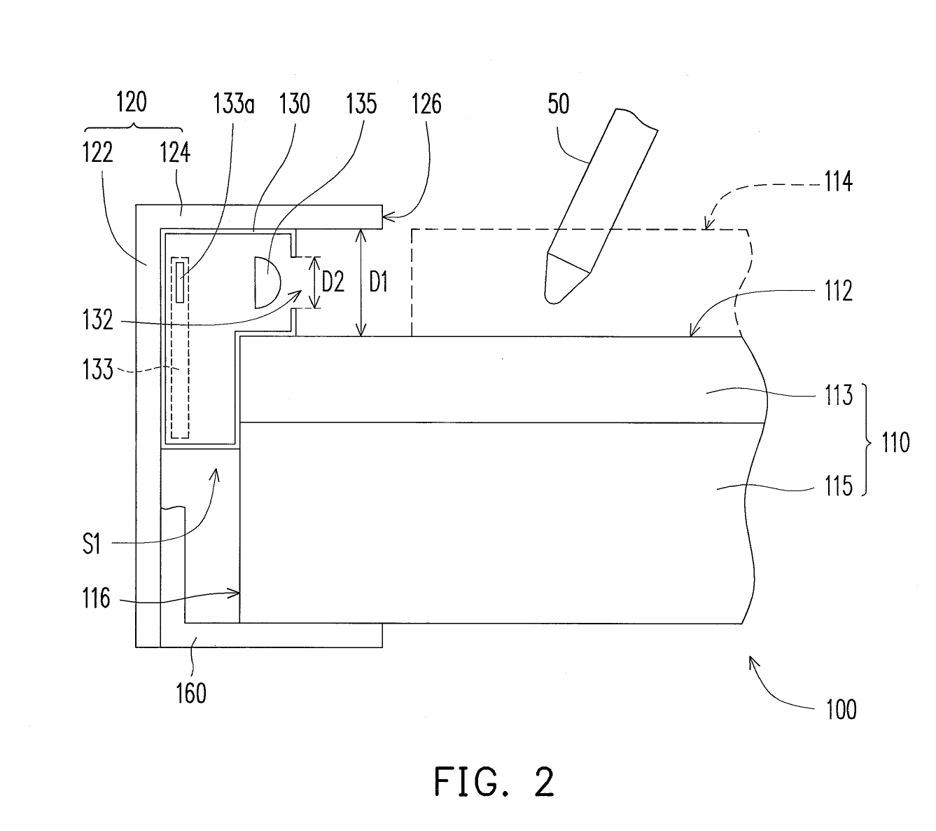

FIG. 1 is a top view of an optical touch-sensing display module according to an embodiment of the invention. FIG. 2 is a partial cross-sectional view of the optical touch-sensing display module of FIG. 1. Referring to FIG. 1 and FIG. 2, in the present embodiment, the optical touch-sensing display module 10 includes a LCD module 100 and two optical touch-sensing units 130. The LCD module 100 includes a LCD device 110 and a frame 120, where the LCD device 110 has a display surface 112 and a side surface 116 located at periphery of the display surface 112. The frame 120 is located at periphery of the display surface 120 and the side surface 116, and has an opening 126 for exposing the display surface 112 of the LCD device 110.

In the present embodiment, the LCD device 110 has four corners, and the optical touch-sensing units 130 are substantially disposed at any two adjacent corners of the four corners. However, the number of the optical touch-sensing units 130 and positions thereof on the LCD device 110 are not limited by the present embodiment, which can be suitably adjusted by a designer under a premise that the touch function is achieved.

The optical touch-sensing units 130 are disposed between the frame 120, the display surface 112 and the side surface 116, and define a sensing space 114 upon the display surface 112. The optical touch unit 130 has a sensing window 132 facing to the sensing space 114. The optical touch unit 130 senses a light variation in the sensing space 114 through the sensing window 132 to identify an object 50 in the sensing space 114.

In detail, in the present embodiment, the LCD module 100 has a containing space S1 between the frame 120, the display surface 112 and the side surface 116. The optical touch-sensing units 130 are disposed in the containing space S1, and the sensing windows 132 are substantially located above the display surface 112 and face to the sensing space 114. In this way, only a portion of the optical touch unit 130 (the sensing window 132) is protruded above the display surface 112 of the LCD module 100, and other portions of the optical touch unit 130 are embedded in the containing space S1 between the side surface 116 and the frame 120. In this way, when the LCD module 100 is assembled with the frame 120, the optical touch-sensing units 130 can be simultaneously assembled, so as to integrate the optical touch-sensing units 130 and the LCD module 100, so that when an optical touch display (not shown) is assembled, a problem of structural configuration between the optical touch-sensing units 130 and a casing (not shown) of the display is avoided. The integral optical touch-sensing display module 10 also has a better applicability, so that a designer can design the casing without considering structural adaptability between the casing and the optical touch-sensing units 130.

In the present embodiment, the frame 120 includes a side plate 122 and a top plate 124 extending from the side plate 122 towards the sensing space 114, where the side plate 122 is opposite to the side surface 116 of the LCD device 110. In other words, the side plate 122, the top plate 124, the side surface 116 and the display surface 114 commonly form the aforementioned containing space S1. In the present embodiment, the sensing window 132 of the optical touch unit 130 is substantially located between the top plate 124 and the display surface 112.

On the other hand, referring to FIG. 2, a height D1 of the top plate 124 relative to the display surface 112 is greater than or equal to a longitudinal height D2 of the sensing window 132. Therefore, the designer can design a thickness of the optical touch unit 130 to be slightly greater than a thickness of an optical element 135 therein, so that the optical element 135 can be fit in the containing space S1 between the frame 120 and the display surface 112, and other portions of the optical touch unit 130 can be disposed in the containing space S1 between the side plate 122 and the side surface 116, so as to effectively use the containing space S1.

In the present embodiment, the LCD module 100 further includes a back frame 150, and the LCD device 110 further includes a backlight module 115 supported on the back frame 150 and a LCD panel 113 disposed on the backlight module 115. The frame 120 is assembled to the back frame 150 with the backlight module 115 and the LCD panel 113, which is known by those skilled in the art, so that detailed description thereof is not repeated.

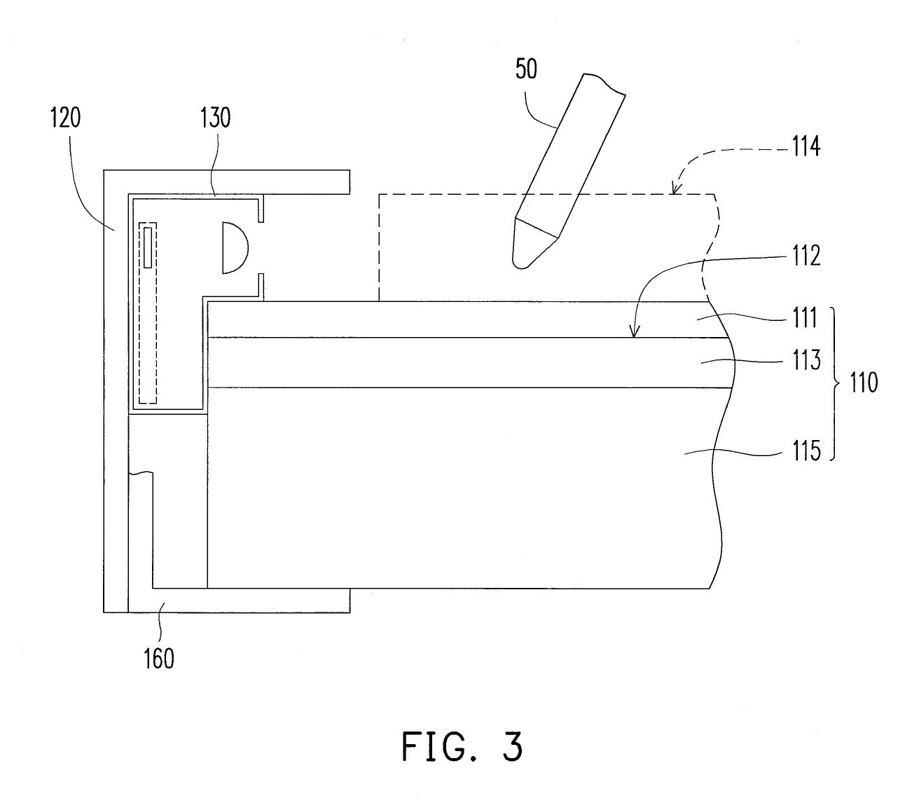

Moreover, FIG. 3 is a partial cross-sectional view of an optical touch-sensing display module according to another embodiment of the invention. Referring to FIG. 3, the LCD device 110 further includes a protection element 111, which is a transparent substrate of a glass material covering on the display surface 112. The sensing window 132 of the optical touch unit 130 is substantially located above the protection element 111. Moreover, the material of the protection element 111 is not limited by the present embodiment, and in other embodiments that are not illustrated, the protection element can also be a transparent acrylic substrate or a protection film plated on the display surface 112.

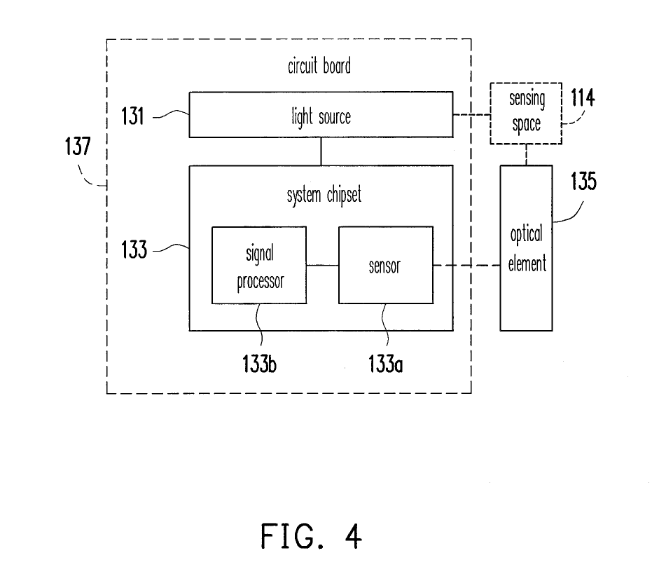

FIG. 4 is a component block diagram of the optical touch unit of FIG. 2, in which solid lines are used to represent electrical connection relationships of the components, and dot lines are used to represent light transmission relationships of the components. Referring to FIG. 2 and FIG. 4, in the present embodiment, each of the optical touch-sensing units 130 includes a light source 131, a system chipset 133, an optical element 135 and a circuit board 137. The light source 131 is, for example, an infrared light source suitable for emitting light towards the sensing space 114. The system chipset 133 is mounted on the circuit board 137 and is electrically connected to the light source 131. The system chipset 133 includes a sensor 133a and a signal processor 133b. Here, the sensing space 114 is defined as a space covered by the light emitted from the light source 131 and capable of being sensed by the sensor 133a.

In the present embodiment, in the system chipset 133, a system on chip (SoC) technique is used to integrate the sensor 133a and the signal processor 133b into a single chip. Moreover, the sensor 133a and the signal processor 133b of the system chipset 133 and the light source 131 can also be packaged in a single system in package (SiP). Here, a combining manner of the system chipset 133 and the related devices is not limited by the present embodiment.

In detail, the light emitted by the light source 131 enters the sensing space 114, and when an object 50 enters the sensing space 114, the sensor 133a senses a difference between the light reflected by the object 50 (or the light shielded by the touch object 50) and the light reflected by the frame 120 through the sensing window 132 and the optical element 135, and the object 50 is imaged on the sensor 133a as a bright spot (or a dark spot). Now, the sensor 133a generates a sensing signal and transmits it to the signal processor 133b, and the signal processor 133b determines a position of the touch object 50 in the sensing space 114 according to the sensing signal.

Referring to FIG. 1, due to a geometric design of the frame 120 and a relative configuration of the optical touch-sensing units 130 and the light sources 131, after the light enters the sensing space 114, light intensity distribution thereof on an inner surface 121 of the frame 120 is uneven, i.e. the light intensity distribution on the frame 120 in the sensing space 114 has a circumstance of partially bright and partially dark. Therefore, in the present embodiment, the frame 120 has a reflection layer 170 at a specific area on the inner surface 121 of the opening 126, so as to compensate light for the relatively dark part of the frame 120, so that the light intensity distribution of the light on the inner surface 121 of the frame 120 can be more even.

In the present embodiment, a reflective material can be plated or coated on the inner surface 121 to form the reflection layer 170, and according to a wavelength of the light, a material suitable of reflecting the light of such wavelength is used as the reflective material. In detail, a method for plating the reflective material on the inner surface 121 includes electroplating, evaporation or other suitable processes, and a method for coating the reflective material on the inner surface 121 includes painting or other suitable methods.

In other words, the reflective material of the present embodiment can be paints suitable for reflecting the light, for example, light-colored paints (white paint). Moreover, the reflective material can be formed on the inner surface 121 through a dot painting manner, so as to produce a plurality of reflection dots on the inner surface 121. Since the refection dots are formed by the reflective material and have a dot-shape distribution, it can also be used to effectively compensate light for the relatively dark part of the frame 120, so that the light intensity distribution of the light on the inner surface 121 of the frame 120 can be more even.

It should be noticed that besides the function of compensating light to uniform the light intensity distribution of the sensing space 114, the reflection layer 170 can also be used in positioning of the sensor 133a before the sensor 133a of the optical touch unit 130 senses the touch object 50. Namely, a sensing angle of the sensor 133a of the optical touch unit 130 in the sensing space 114 can be adjusted according to the reflection layer 170, so that the sensor 133a can fully sense anywhere of the sensing space 114.

Here, a light emitting manner of the light source used by the optical touch-sensing unit for achieving the touch control effect is not limited by the invention.

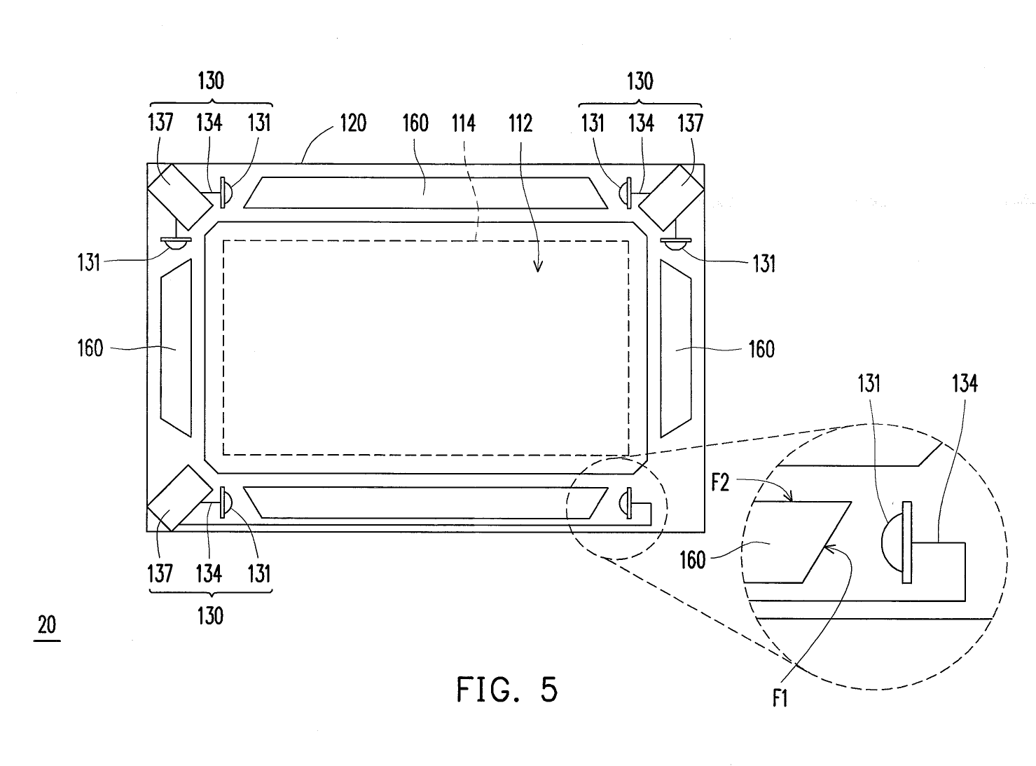

FIG. 5 is a top view of an optical touch-sensing display module according to another embodiment of the invention, in which outlines of a part of the components are omitted to clearly present relative relations of the components. Different to that of the above embodiment, the optical touch-sensing display module 20 of the present embodiment includes three optical touch-sensing units 130, four light guides 160 and a plurality of light sources 131. The light guides 160 are disposed next to the optical touch-sensing units 130 at periphery of the display surface 112. Each of the light guides 160 has two light incident surfaces F1 and a light-emitting surface F2 between the light incident surfaces F1, where the light-emitting surface F2 faces to the sensing space 114, and each of the light sources 131 is adjacent to the light-incident surface F1 of the light guides 160, so that the light emitted from the light source 131 is transmitted to the sensing space 114 through the light incident surface F1 and the light-emitting surface F2 of the light guides plate 160. Here, due to a structural limitation of the frame 120 (shown in FIG. 2), the light sources 131 cannot be fixedly mounted on the circuit board 137, but are electrically connected to the system chipsets 133 through conductive wires 134. In this way, the light source 131 may generate a light field with even brightness in the sensing space 114 through the light guides 160, so as to achieve the same effect with that of the above embodiment.

Here, lengths and the number of the light guides 160 and the number of the light sources 131 corresponding to the optical touch-sensing units 130 are not limited by the present embodiment, and the designer can suitably adjust the number of the light guides 160 and the number of the light sources 131 according to an internal space of the frame 120 and a brightness of the sensing space 114. For example, when the length of the light guides 160 is relatively long, the light sources 131 can be adjacent to both of the light-incident surfaces Fl of the light guides 160. Comparatively, when the length of the light-guiding plate 160 is relatively short, the light source 131 is adjacent to only one of the light-incident surfaces F1.

Moreover, in another embodiment that is not illustrated, the circuit board is a flexible circuit board, so that the light sources can be directly mounted on the circuit board.

On the other hand, a manner that the sensor 133a senses the touch object 50 is not limited by the invention, and in another embodiment that is not illustrated, the sensor can also obtain the position of the object in the sensing space by directly sensing an image of the object.

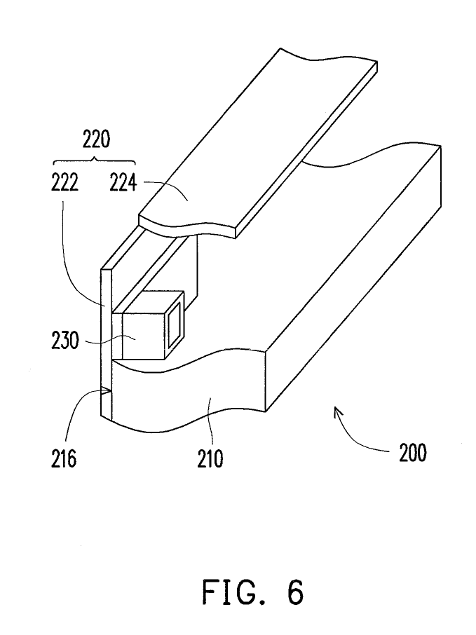

In the present embodiment, only the sensing window 132, the optical element 135 and the system chipset 133 of the optical touch unit 130 are disposed above the display surface 112, and other components (for example, the circuit board 137) are embedded between the side plate 122 and the side surface 116, so as to effectively use the containing space S1 between the frame 120 and the LCD device 110, though the invention is not limited thereto. FIG. 6 is a partial cross-sectional view of an optical touch-sensing display module according to another embodiment of the invention. Referring to FIG. 6, in the LCD module 200 of the present embodiment, a side plate 222 of a frame 220 is closely attached to a side surface 216 of a LCD device 210, and an optical touch unit 230 is disposed between the LCD device 210 and a top plate 224.

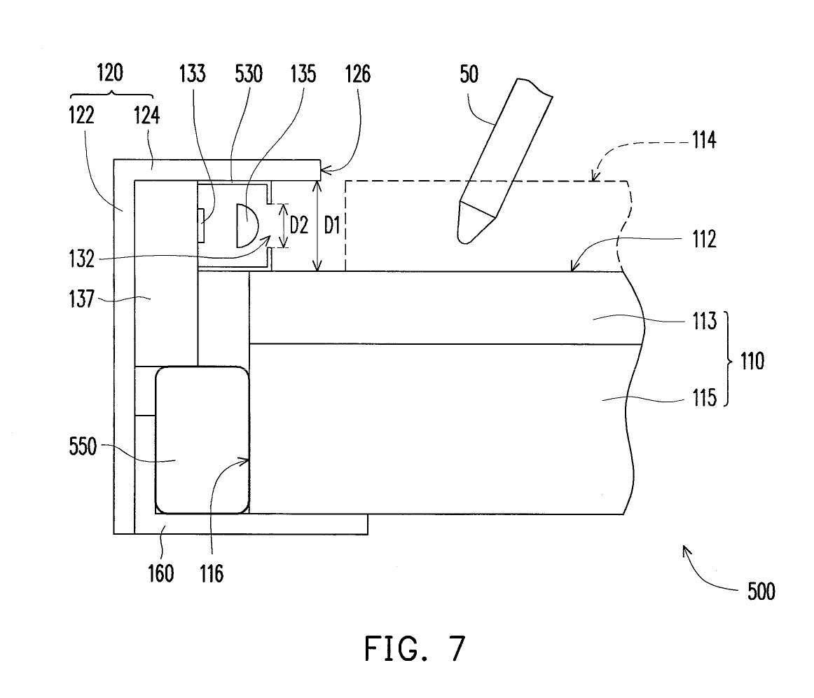

Moreover, FIG. 7 is a partial cross-sectional view of an optical touch-sensing display module according to another embodiment of the invention. Referring to FIG. 7, different to the above embodiment, an optical touch-sensing unit 530 is disposed between the frame 120, the display surface 112 and the side surface 116 of the LCD module 500 through an auxiliary element 550, where the auxiliary element 550 is, for example, a turning plate or a pad, or any element that can stably fix the optical touch-sensing unit between the frame, the display surface and the side surface.

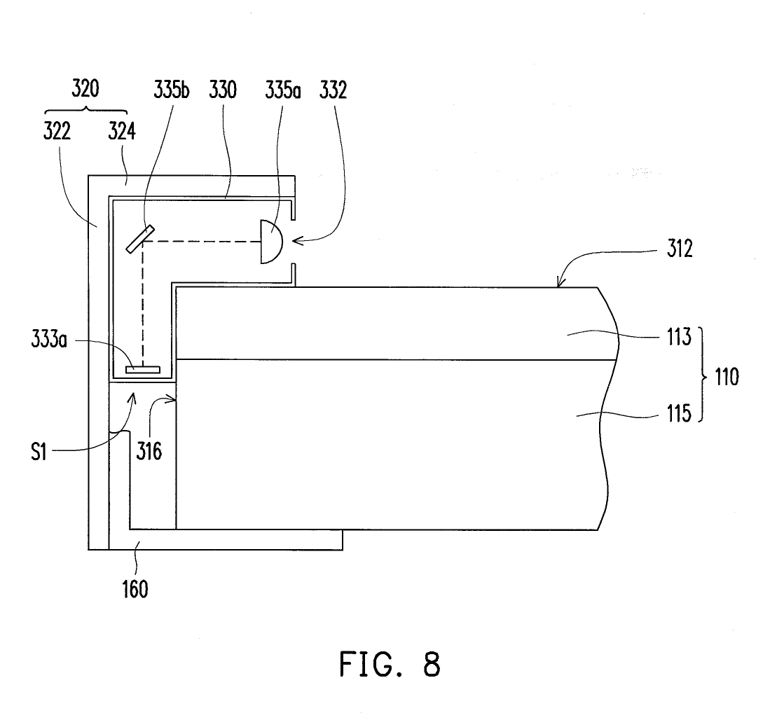

Compared to the embodiment of FIG. 2, in which the sensor 133a directly faces to the sensing window 132 for receiving the light transmitted through the sensing window 132. FIG. 8 is a partial cross-sectional view of an optical touch-sensing display module according to another embodiment of the invention. Referring to FIG. 8, in the present embodiment, an optical touch unit 330 further includes a lens 335a and a reflection mirror 335b, where the lens 335a is used for collecting the light transmitted through a sensing window 332. The sensing window 332, the lens 335a and the reflection mirror 335b are all disposed between a top plate 324 of a frame 320 and a display surface 312, and a sensing element 333a is disposed between a side surface 316 of a LCD device 310 and a side plate 322. In this way, the light collected by the lens 335a is reflected to the sensor 333a through the reflection mirror 335b, and based on such periscope-type optical structure, the present embodiment can also achieve the same effect as that of the above embodiment.

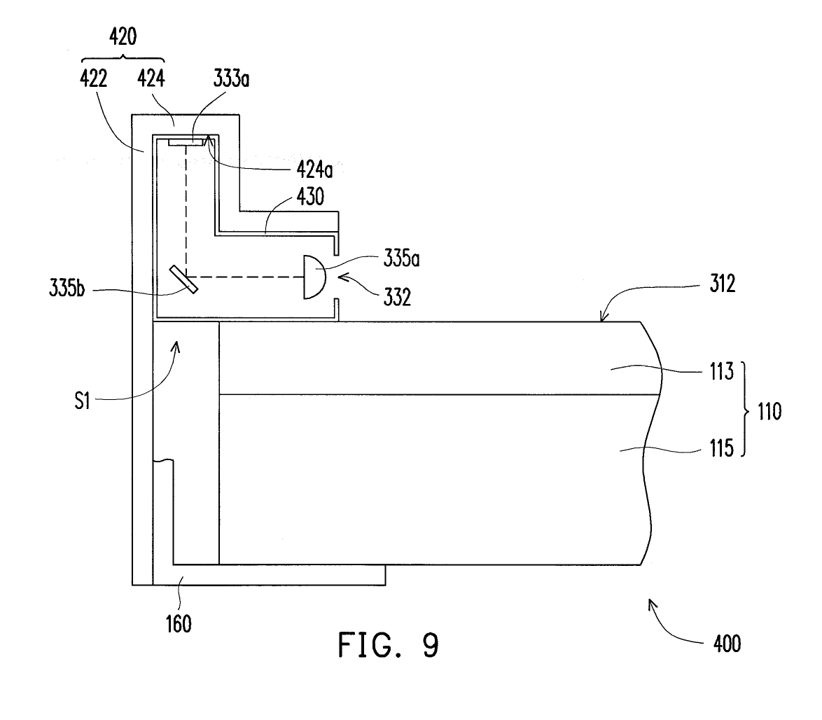

FIG. 9 is a partial cross-sectional view of an optical touch-sensing display module according to another embodiment of the invention. The same components in FIG. 9 and FIG. 8 are not repeated, and a difference between the embodiments of FIG. 9 and FIG. 8 is that a frame 420 has a recess portion 424a located between a top plate 424 and a side plate 422, and the sensor 333a is substantially located in the recess portion 424a. For example, when the frame 420 is fabricated, a sheet-metal processing technique such as a punching or a bending process can be used to fabricate the recess portion 424a at the top plate 424 (or the side plate 422), so that when the LCD module 400 is assembled, the optical touch-sensing unit 430 can also be simultaneously embedded in the recess portion 424a.

According to the above embodiments, it is known that the method of disposing the optical touch-sensing units in the containing space is not limited by the invention, and any method capable of disposing the optical touch-sensing units in the containing space of the LCD module, and ensures the sensing windows of the optical touch-sensing units facing to the sensing space so as to transmit the light reflected by the touch object to the sensors can be used in the invention.

In summary, in the optical touch-sensing display module of the invention, the optical touch-sensing units are disposed in the LCD module, so that when the LCD module is assembled, the optical touch-sensing units are simultaneously assembled. In this way, the optical touch-sensing units and the LCD module may have an integral design, so as to save follow-up assembling processes of the optical touch display and improve an application range of the optical touch-sensing display module.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An optical touch-sensing display module, comprising:
a liquid crystal display module, having a display surface and a side surface located at periphery of the display surface, and the liquid crystal display module comprising:
a frame, located at periphery of the display surface and the side surface, and having an opening for exposing the display surface; and
at least two optical touch-sensing units, disposed between the frame, the display surface and the side surface, and defining a sensing space upon the display surface, wherein each of the optical touch-sensing units has a sensing window facing to the sensing space, and each of the optical touch-sensing units senses an object in the sensing space through the sensing window.

2. The optical touch-sensing display module as claimed in claim 1, wherein the liquid crystal display module has a containing space located between the frame, the display surface and the side surface, the optical touch-sensing units are disposed in the containing space, and the sensing window of each of the optical touch-sensing units is located above the display surface.

3. The optical touch-sensing display module as claimed in claim 2, wherein the frame comprises:
a side plate, opposite to the side surface of the liquid crystal display module; and
a top plate, extending from the side plate towards the sensing space, wherein the containing space is formed with the side plate, the top plate, the side surface and the display surface, and the sensing window of each of the optical touch-sensing units is located between the top plate and the display surface.

4. The optical touch-sensing display module as claimed in claim 3, wherein each of the optical touch-sensing units comprises:
a sensor; and
at least one optical element, disposed between the sensor and the sensing window, wherein the sensor senses the object through the optical element and the sensing window.

5. The optical touch-sensing display module as claimed in claim 4, wherein the sensor directly faces to the sensing window.

6. The optical touch-sensing display module as claimed in claim 4, wherein the sensor is located between the side plate and the side surface.

7. The optical touch-sensing display module as claimed in claim 4, wherein the top plate has a recess portion, and the sensor is located in the recess portion.

8. The optical touch-sensing display module as claimed in claim 4, wherein each of the optical touch-sensing units further comprises:
a circuit board;
a light source, for emitting light to the sensing space; and
a system chipset, mounted on the circuit board and electrically connected to the light source, and comprising a signal processor and the sensor electrically connected to each other.

9. The optical touch-sensing display module as claimed in claim 8, wherein each of the optical touch-sensing units further comprises a conductive wire connected to the light source and the circuit board.

10. The optical touch-sensing display module as claimed in claim 8, wherein the circuit board is a flexible circuit board, and the light source is mounted on the flexible circuit board.

11. The optical touch-sensing display module as claimed in claim 8, further comprising:
a plurality of light guides, disposed in the containing space at periphery of the display surface, and located next to the optical touch-sensing units, wherein each of the light guides has two light-incident surfaces and a light-emitting surface between the light-incident surfaces, the light-emitting surface faces to the sensing space, and the light sources are respectively disposed adjacent to the light-incident surface, for emitting light passing through the light-incident surface and the light-emitting surface of the light guide and then entering the sensing space.

12. The optical touch-sensing display module as claimed in claim 1, wherein the liquid crystal display module comprises:
a protection element, covering the display surface, and the sensing window of each of the optical touch-sensing units being located above the protection element.

13. The optical touch-sensing display module as claimed in claim 1, wherein the frame has a reflection area on an inner surface at the opening.

14. An optical touch-sensing display module comprising:
a liquid crystal display device, having a display surface and four side surfaces;
a frame, disposed at periphery of the liquid crystal display device, wherein a containing space is formed between the frame and the liquid crystal display device, and the frame has an opening for exposing the display surface, and defines a sensing space upon the display surface; and
a plurality of optical touch-sensing units, disposed in the containing space,
wherein each of the optical touch-sensing units has a sensing window facing to the sensing space, and each of the optical touch-sensing units senses an object in the sensing space through the sensing window.

15. The optical touch-sensing display module as claimed in claim 14, further comprising a back frame being assembled to the frame, wherein the liquid crystal display device comprises:
a backlight module, being supported on the back frame; and
a liquid crystal display panel, disposed on the backlight module.

16. The optical touch-sensing display module as claimed in claim 15, wherein the liquid crystal display device further comprises a transparent substrate disposed on an upper surface of the liquid crystal display panel.

17. The optical touch-sensing display module as claimed in claim 14, wherein each of the optical touch-sensing units comprises:
a sensor; and
at least one optical element, disposed between the sensor and the sensing window, wherein the sensor senses the object through the optical element and the sensing window.

18. The optical touch-sensing display module as claimed in claim 14, wherein the liquid crystal display device has four corners, and at least two of the optical touch-sensing units are substantially located at any two adjacent corners of the four corners of the liquid crystal display device.

19. The optical touch-sensing display module as claimed in claim 14, wherein the containing space is formed with the frame and the display surface.

20. The optical touch-sensing display module as claimed in claim 14, wherein the containing space is formed with the frame, the display surface and the side surface.

21. An optical touch-sensing display module, comprising:
a liquid crystal display module, having a display surface and a side surface at periphery of the display surface, the liquid crystal display module comprising:
a frame, located at periphery of the display surface and the side surface, and having an opening for exposing the display surface, wherein a containing space is formed between the frame and the display surface and the side surface of the liquid crystal display module;
at least two optical touch-sensing units, disposed in the containing space, and defining a sensing space upon the display surface, wherein each of the optical touch-sensing units has a sensing window, and the sensing window is located above the display surface and faces to the sensing space, and each of the optical touch-sensing units comprises:
a light source;
a system chipset, comprising a signal processor and a sensor, wherein the sensor directly faces to the sensing window;
at least one optical element, disposed between the sensor and the sensing window; and
a plurality of light guides, disposed in the containing space, and each having two light-incident surfaces and a light-emitting surface between the light incident surfaces, wherein the light-emitting surface faces to the sensing space, and the light sources are adjacent to at least one of the light-incident surfaces for emitting light to the sensing space through the light-incident surfaces and the light-emitting surfaces, the sensor of each of the optical touch-sensing units senses the light variation in the sensing space through the sensing window when at least one object enters the sensing space.

22. An optical touch-sensing display module, comprising:
a liquid crystal display device, having a display surface and four side surfaces;
a frame, disposed at periphery of the liquid crystal display device, and having a top plate and a side plate adjoined to each other, wherein the top plate has an opening for exposing the display surface, and defines a sensing space upon the display surface, and the side plate is opposite to the side surfaces;
a plurality of optical touch-sensing units, and each of the optical touch-sensing units comprising:
at least one light source;
a sensor; and
a circuit board, disposed between the frame and the liquid crystal display device, wherein the sensor is mounted on the circuit board and the light source is electrically connected to the circuit board, wherein a part of the circuit board is located between at least one of the side surfaces and the side plate, and another part of the circuit board between the side plate and the side surface extends towards the top plate.
